(19) United States
(12) Patent Application Publication
(10) Pub. No.: US 2025/0217799 A1
(43) Pub. Date: Jul. 3, 2025

(54) MACHINE LEARNING BASED SYSTEMS AND METHODS FOR IDENTIFICATION OF PAYMENT INFORMATION FROM ELECTRONIC MAILS

(71) Applicant: HIGHRADIUS CORPORATION, Houston, TX (US)

(72) Inventors: Rehan Ahmad, Hyderabad (IN); Debanwesh Bose, Hyderabad (IN); Hashwanth Maripina, Hyderabad (IN); Aishwarya Kumar, Hyderabad (IN)

(21) Appl. No.: 18/396,759

(22) Filed: Dec. 27, 2023

(51) Int. Cl. G06Q 20/38; G06F 40/284; H04L 51/08

(52) U.S. Cl. CPC G06Q 20/386; G06F 40/284; H04L 51/08

(57) ABSTRACT

A machine learning based computing method for determining payment information from electronic mails, is disclosed. The machine learning based computing method includes steps of: receiving data from databases; extracting information tokens from the data associated with electronic mails and electronic documents; determining payment information features for the information tokens by analyzing contexts of the information tokens extracted from the data associated with electronic mails and electronic documents; selecting optimum information tokens by analyzing the payment information features by parameter-driven pre-configured rules; determining first payment information including payment amounts and payment identifiers within the electronic mails and the electronic documents, for the optimum information tokens by a machine learning model; and providing an output of the first payment information including the payment amounts and the payment identifiers to users on a user interface associated with electronic devices.

### FIELD OF INVENTION

Embodiments of the present disclosure relate to machine learning based (ML-based) computing systems, and more particularly relates to a ML-based computing method and system for determining one or more payment information from at least one of one or more electronic mails and one or more electronic documents attached in the one or more electronic mails.

### BACKGROUND

A remittance document, often referred to as at least one of: a remittance advice and a remittance slip, is a document typically sent by a customer or debtor to a business along with a payment. The remittance document serves as a communication tool to provide essential information regarding the payment being made. Remittance documents are essential in accounts receivables and financial management processes of businesses. The remittance documents help streamline reconciliation of payments, reduce errors, and ensure that funds are allocated correctly to at least one of: outstanding invoices and accounts.

The current workflow in accounts receivables departments involves a manual process for handling payments received from debtors through electronic mail attachments. Initially, when an electronic mail is received, the electronic mail typically includes an attachment related to the remittance document. Subsequently, an accounts receivables executive manually opens the electronic mail attachment and extracts essential information, specifically at least one of: payment identifier and payment amount, from the remittance document. The extracted details are then recorded manually. Following this, the recorded payment identifier and payment amount are used to locate and update the corresponding entry in a accounts receivables database.

The above manual process has several drawbacks. Primarily, the drawback lies in its reliance on a labour-intensive and time-consuming manual process. Depending on human intervention for data extraction and recording makes it vulnerable to a range of errors, from misinterpreting information to typos and inadvertent mistakes. Additionally, the manual process lacks efficiency, requiring significant human effort. Further, the manual process introduces potential delays in updating the accounts receivables database, which could negatively impact organization's financial operations and decision-making processes. To sum it up, the manual process is not only labour-intensive but also highly error-prone, making it an inefficient and potentially costly process for managing accounts receivables.

Hence, there is a need for an improved machine learning based (ML-based) computing system and method for determining one or more payment information from at least one of: one or more electronic mails and one or more electronic documents attached in the one or more electronic mails, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) computing method for automatically determining one or more payment information from one or more electronic mails, is disclosed. The ML-based computing method comprises receiving, by one or more hardware processors, one or more data from one or more databases. The one or more data comprise at least one of: the one or more electronic mails and one or more electronic documents attached in the one or more electronic mails.

The ML-based computing method further comprises extracting, by the one or more hardware processors, one or more information tokens from the one or more data associated with at least one of: the one or more electronic mails and the one or more electronic documents attached in the one or more electronic mails.

The ML-based computing method further comprises determining, by the one or more hardware processors, one or more payment information features for the one or more information tokens by analyzing one or more contexts of the one or more information tokens extracted from at least one of: the one or more electronic mails and the one or more electronic documents attached in the one or electronic mails. The one or more payment information features are configured to determine whether the one or more information tokens comprise one or more contents related to one or more first payment information. The one or more first payment information comprise at least one of: one or more payment amounts and one or more payment identifiers.

The ML-based computing method further comprises selecting, by the one or more hardware processors, one or more optimum information tokens by analyzing the determined one or more payment information features by one or more parameter-driven pre-configured rules.

The ML-based computing method further comprises determining, by the one or more hardware processors, the one or more first payment information comprising at least one of: the one or more payment amounts and the one or more payment identifiers within at least one of: the one or more electronic mails and the one or more electronic documents, for the one or more optimum information tokens by a machine learning model.

The ML-based computing method further comprises providing, by the one or more hardware processors, an output of the determined one or more first payment information comprising at least one of: the one or more payment amounts and the one or more payment identifiers to one or more users on a user interface associated with one or more electronic devices.

In an embodiment, extracting the one or more information tokens comprises: (a) converting, by the one or more hardware processors, the one or more data associated with at least one of: the one or more electronic mails and the one or more electronic documents to one or more text formats, based on at least one of: an industry standard parser process and an industry standard conversion process; and (b) transforming, by the one or more hardware processors, the one or more text formats into the one or more information tokens, based on a tokenization process.

In another embodiment, the one or more payment information features comprise at least one of: horizontal distance from one or more first payment keywords, vertical distance from the one or more first payment keywords, horizontal distance from one or more second payment keywords, vertical distance from the one or more second payment keywords, one or more zip codes, recurrence of the one or more information tokens, and one or more positions of the one or more information tokens.

In yet another embodiment, determining, by the machine learning model, the one or more first payment information comprising at least one of: the one or more payment amounts and the one or more payment identifiers within at least one of: the one or more electronic mails and the one or more electronic documents, for the one or more optimum information tokens, comprises: (a) generating, by the one or more hardware processors, one or more confidence scores for the one or more optimum information tokens; and (b) labelling, by the one or more hardware processors, the one or more optimum information tokens to classify the one or more optimum information tokens into at least one of: the one or more payment amounts, the one or more payment identifiers and one or more non-payment information, based on the one or more confidence scores generated for the one or more optimum information tokens by one or more predetermined threshold values.

The one or more confidence scores for the one or more optimum information tokens indicate quantitative measure of the one or more first payment information comprising at least one of: the one or more payment amounts and the one or more payment identifiers, available in the one or more optimum information tokens. The one or more confidence scores are generated for the one or more optimum information tokens based on at least one of: the determined one or more payment information features and one or more first weights assigned to the one or more payment information features based on the availability of the one or more first payment information comprising at least one of: the one or more payment amounts and the one or more payment identifiers in the one or more optimum information tokens. The one or more non-payment information are distinct from the one or more first payment information.

In yet another embodiment, the one or more optimum information tokens are classified as the one or more non-payment information when the one or more confidence scores for the one or more payment amounts and the one or more payment identifiers, are within the one or more predetermined threshold values. The one or more optimum information tokens are classified as the one or more payment amounts when at least one of: the one or more confidence scores for the one or more payment amounts are at least one of: equal and exceed the one or more predetermined threshold values, and the one or more confidence scores for the one or more payment identifiers are within the one or more predetermined threshold values.

The one or more optimum information tokens are classified as the one or more payment identifiers when at least one of: the one or more confidence scores for the one or more payment identifiers are at least one of: equal and exceed the one or more predetermined threshold values, and the one or more confidence scores for the one or more payment amounts are within the one or more predetermined threshold values. The one or more optimum information tokens are classified as at least one of: the one or more payment amounts and the one or more payment identifiers, based on one or more first optimum confidence scores generated for at least one of: the one or more payment amounts and the one or more payment identifiers, when at least one of: the one or more confidence scores for the one or more payment identifiers and the one or more payment amounts are at least one of: equal and exceed the one or more predetermined threshold values.

In yet another embodiment, determining, by the machine learning model, the one or more first payment information further comprises: (a) classifying, by the one or more hardware processors, the one or more optimum information tokens with one or more second optimum confidence scores related to the one or more payment amounts, as one or more optimum payment amounts, when the one or more confidence scores related to the one or more payment amounts are generated for the one or more optimum information tokens; and (b) classifying, by the one or more hardware processors, the one or more optimum information tokens with one or more third optimum confidence scores related to the one or more payment identifiers, as one or more optimum payment identifiers, when the one or more confidence scores related to the one or more payment identifiers are generated for the one or more optimum information tokens.

In yet another embodiment, the ML-based computing method further comprises training, by the one or more hardware processors, the machine learning model, by: (a) obtaining, by the one or more hardware processors, one or more labelled datasets from the one or more databases; (b) selecting, by the one or more hardware processors, one or more features vectors associated with the one or more payment information features for training the machine learning model based on a feature engineering process; (c) labelling, by the one or more hardware processors, the one or more optimum information tokens to classify the one or more optimum information tokens into at least one of: the one or more payment amounts, the one or more payment identifiers and the one or more non-payment information; (d) segmenting, by the one or more hardware processors, the one or more labelled datasets into at least one of: one or more training datasets and one or more validation datasets; (e) training, by the one or more hardware processors, the machine learning model to correlate the one or more feature vectors associated with the one or more payment information features, with at least one of: the one or more payment amounts and the one or more payment identifiers, based on one or more hyperparameters; and (f) generating, by the one or more hardware processors, the one or more confidence scores for the one or more optimum information tokens, based on the trained machine learning model.

The one or more labelled datasets comprise the one or more information tokens extracted from at least one of: the one or more electronic mails and the one or more electronic documents attached in the one or more electronic mails. The machine learning model comprises a random forest based machine learning model. The one or more hyperparameters comprise at least one of: max_depth, class_weight, n_estimators, min_samples_split, max_features, and min_samples_leaf.

The max_depth hyperparameter is configured to control an optimum depth of each decision tree in the random forest based machine learning model. The class_weight hyperparameter is configured to adjust one or more second weights of one or more classes in the random forest based machine learning model to control one or more class imbalance errors. The n_estimators hyperparameter is configured to indicate a number of one or more decision trees to be included in the random forest based machine learning model. The min_samples_split hyperparameter is configured to set a pre-determined number of one or more data points required in a node before the one or more data points split during a tree-building process. The max_features hyperparameter is configured to determine an optimum number of the one or more payment information features when the optimum split of the one or more payment information features at each node in the random forest based machine learning model. The min_samples_leaf is configured to indicate the pre-determined number of one or more data points required to generate a leaf node during the tree-building process.

In yet another embodiment, the ML-based computing method further comprises validating, by the one or more hardware processors, the machine learning model based on the one or more validation datasets by determining, by the one or more hardware processors, whether one or more metric scores attained by the trained machine learning model, exceeds one or more pre-determined threshold values. The one or more metric scores are associated with one or more validation metrics comprising at least one of: precision metric, recall metric, F1-score metric, and confusion metric.

In yet another embodiment, the ML-based computing method further comprises adjusting, by the one or more hardware processors, the one or more hyperparameters to fine-tune the machine learning model based on one or more results of validation of the machine learning model.

In yet another embodiment, the ML-based computing method further comprises re-training, by the one or more hardware processors, the machine learning model over a plurality of time intervals based on one or more training data by (a) receiving, by the one or more hardware processors, the one or more training data associated with at least one of: the one or more electronic mails and the one or more electronic documents attached in the one or more electronic mails; (b) adding, by the one or more hardware processors, the one or more training data with the one or more training datasets to generate one or more updated training datasets; (c) re-training, by the one or more hardware processors, the machine learning model to correlate the one or more feature vectors associated with the one or more payment information features, with at least one of: the one or more payment amounts and the one or more payment identifiers; and (d) executing, by the one or more hardware processors, the re-trained machine learning model in a payment information determining subsystem to determine the one or more first payment information comprising at least one of: the one or more payment amounts and the one or more payment identifiers within at least one of: the one or more electronic mails and the one or more electronic documents. The one or more confidence scores are generated based on re-training the machine learning model.

In one aspect, a machine learning based (ML-based) computing system for automatically determining one or more payment information from one or more electronic mails, is disclosed. The ML-based computing system includes one or more hardware processors and a memory coupled to the one or more hardware processors. The memory includes a plurality of subsystems in the form of programmable instructions executable by the one or more hardware processors.

The plurality of subsystems comprises a data receiving subsystem configured to receive one or more data from one or more databases. The one or more data comprise at least one of: the one or more electronic mails and one or more electronic documents attached in the one or more electronic mails.

The plurality of subsystems further comprises a token extraction subsystem configured to extract one or more information tokens from the one or more data associated with at least one of: the one or more electronic mails and the one or more electronic documents attached in the one or more electronic mails.

The plurality of subsystems further comprises a payment information feature determining subsystem configured to determine one or more payment information features for the one or more information tokens by analyzing one or more contexts of the one or more information tokens extracted from at least one of: the one or more electronic mails and the one or more electronic documents attached in the one or electronic mails.

The one or more payment information features are configured to determine whether the one or more information tokens comprise one or more contents related to one or more first payment information. The one or more first payment information comprise at least one of: one or more payment amounts and one or more payment identifiers.

The plurality of subsystems further comprises a token selection subsystem configured to select one or more optimum information tokens by analyzing the determined one or more payment information features by one or more parameter-driven pre-configured rules.

The plurality of subsystems further comprises a payment information determining subsystem configured to determine the one or more first payment information comprising at least one of: the one or more payment amounts and the one or more payment identifiers within at least one of: the one or more electronic mails and the one or more electronic documents, for the one or more optimum information tokens by a machine learning model.

The plurality of subsystems further comprises an output subsystem configured to provide an output of the determined one or more first payment information comprising at least one of: the one or more payment amounts and the one or more payment identifiers to one or more users on a user interface associated with one or more electronic devices.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based (ML-based) computing system for determining one or more payment information from one or more electronic mails, in accordance with an embodiment of the present disclosure;

FIG. 2 is a detailed view of the ML-based computing system for determining the one or more payment information from the one or more electronic mails, in accordance with another embodiment of the present disclosure;

FIG. 3 is an overall process flow of determining the one or more payment information from the one or more electronic mails, in accordance with another embodiment of the present disclosure;

FIG. 4 is a process flow of training a random forest based machine learning model for determining the one or more payment information from the one or more electronic mails, in accordance with an embodiment of the present disclosure;

FIG. 5 is an exemplary graphical representation depicting an output of the determined one or more payment information from the one or more electronic mails, on a user interface associated with one or more electronic devices, in accordance with an embodiment of the present disclosure; and

FIG. 6 is a flow chart illustrating a machine-learning based (ML-based) computing method for determining the one or more payment information from the one or more electronic mails, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

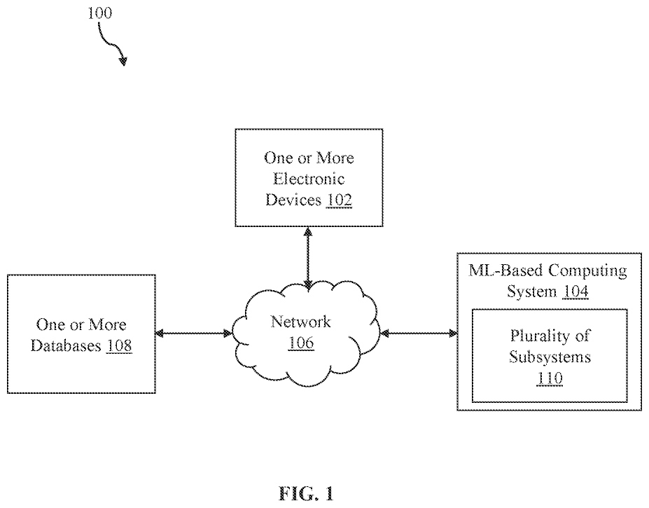

Referring now to the drawings, and more particularly to FIG. 1 through FIG. 6, where similar reference characters denote corresponding features consistently throughout the figures, there are shown preferred embodiments and these embodiments are described in the context of the following exemplary system and/or method.

FIG. 1 is a block diagram illustrating a computing environment 100 with a machine learning based (ML-based) computing system 104 for determining one or more payment information from one or more electronic mails, in accordance with an embodiment of the present disclosure. According to FIG. 1, the computing environment 100 includes one or more electronic devices 102 that are communicatively coupled to the ML-based computing system 104 through a network 106. The one or more electronic devices 102 through which one or more users provide one or more inputs to the ML-based computing system 104.

In an embodiment, the one or more users may include at least one of: one or more data analysts, one or more business analysts, one or more cash analysts, one or more financial analysts, one or more collection analysts, one or more debt collectors, one or more professionals associated with cash and collection management, and the like.

The present invention is configured to provide determined one or more first payment information comprising at least one of: the one or more payment amounts and the one or more payment identifiers, to the one or more users through the one or more electronic devices 102. The ML-based computing system 104 is initially configured to receive one or more data from one or more databases 108. The one or more data include at least one of: the one or more electronic mails and one or more electronic documents attached in the one or more electronic mails. In an embodiment, the one or more data may be encrypted and decrypted by the ML-based computing system 104 so that one or more third party users cannot be authenticated to manipulate the one or more data.

The ML-based computing system 104 is further configured to extract one or more information tokens from the one or more data associated with at least one of: the one or more electronic mails and the one or more electronic documents attached in the one or more electronic mails. The ML-based computing system 104 is further configured to determine one or more payment information features for the one or more information tokens by analyzing one or more contexts of the one or more information tokens extracted from at least one of: the one or more electronic mails and the one or more electronic documents in the one or electronic mails. In an embodiment, the determined one or more payment information features are configured to determine whether the one or more information tokens include one or more contents related to one or more first payment information. The one or more first payment information may include at least one of: one or more payment amounts and one or more payment identifiers.

The ML-based computing system 104 is further configured to select one or more optimum information tokens by analyzing the determined one or more payment information features by one or more parameter-driven pre-configured rules. The ML-based computing system 104 is further configured to determine the one or more first payment information including at least one of: the one or more payment amounts and the one or more payment identifiers within at least one of: the one or more electronic mails and the one or more electronic documents, for the one or more optimum information tokens by a machine learning model. The ML-based computing system 104 is further configured to provide an output of the determined one or more first payment information including at least one of: the one or more payment amounts and the one or more payment identifiers to one or more users on a user interface associated with the one or more electronic devices 102.

The ML-based computing system 104 may be hosted on a central server including at least one of: a cloud server or a remote server. Further, the network 106 may be at least one of: a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes the one or more databases 108 communicatively coupled to the ML-based computing system 104 through the network 106. In an embodiment, the one or more databases 108 includes at least one of: one or more relational databases, one or more object-oriented databases, one or more data warehouses, one or more cloud-based databases, and the like. In another embodiment, a format of the one or more data generated from the one or more databases 108 may include at least one of: a comma-separated values (CSV) format, a JavaScript Object Notation (JSON) format, an Extensible Markup Language (XML), spreadsheets, and the like. Furthermore, the one or more electronic devices 102 include at least one of: a local browser, a mobile application, and the like.

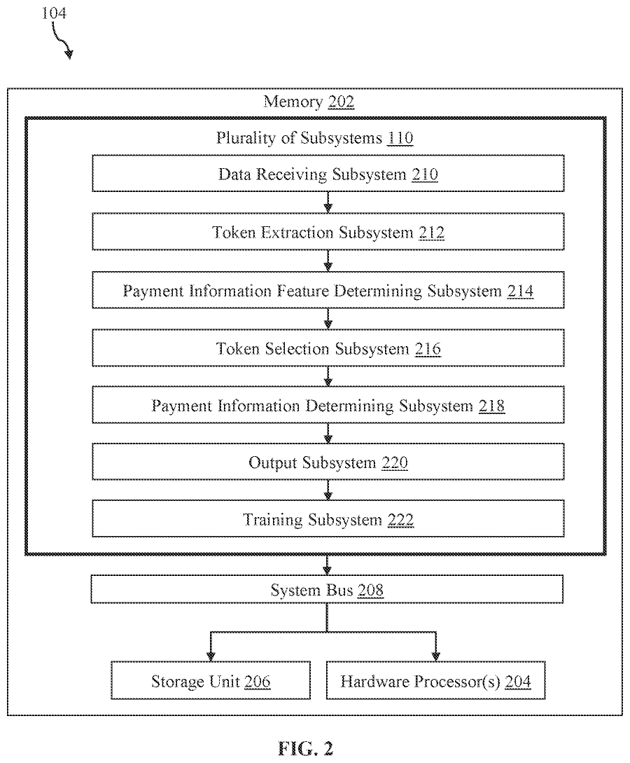

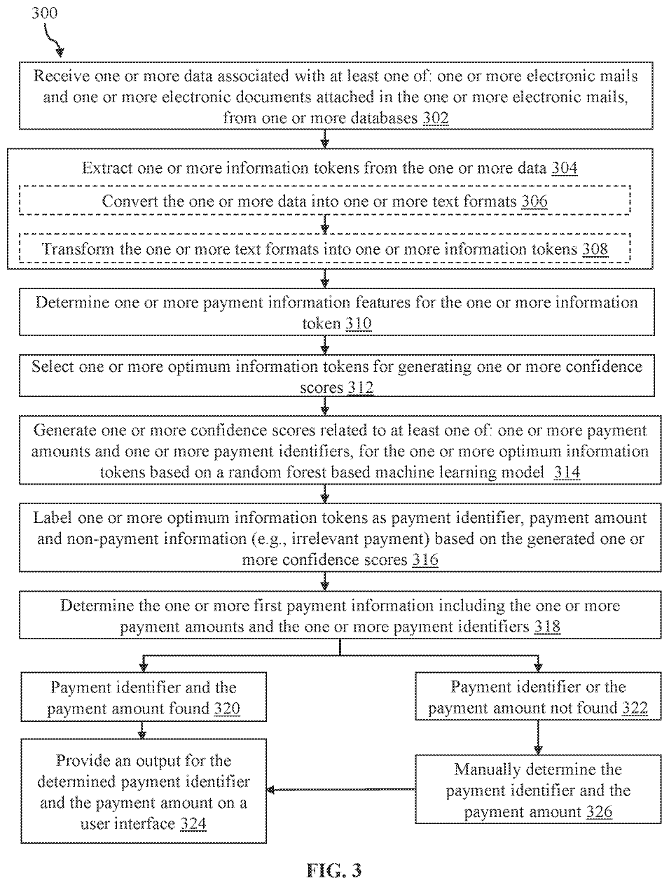

Furthermore, the one or more users may use a web application through the local browser, the mobile application to communicate with the ML-based computing system 104. In an embodiment of the present disclosure, the ML-based computing system 104 includes a plurality of subsystems 110. Details on the plurality of subsystems 110 have been elaborated in subsequent paragraphs of the present description with reference to FIG. 2.

FIG. 2 is a detailed view of the ML-based computing system 104 for determining the one or more unique identifiers associated with the one or more first users based on the one or more information associated with the one or more financial transactions, in accordance with another embodiment of the present disclosure. The ML-based computing system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes a data receiving subsystem 210, a token extraction subsystem 212, a payment information feature determining subsystem 214, a token selection subsystem 216, a payment information determining subsystem 218, an output subsystem 220, and a training subsystem 222. The brief details of the plurality of subsystems 110 have been elaborated in a below table.

| Plurality of | |
|---|---|
| Subsystems 110 | Functionality |
| Data receiving | The data receiving subsystem 210 is configured to receive one or |
| subsystem 210 | more data from the one or more databases 108. The one or more |
| | data may include at least one of: the one or more electronic mails |
| | and one or more electronic documents attached in the one or |
| | more electronic mails. |
| Token | The token extraction subsystem 212 is configured to extract the |
| extraction | one or more information tokens from the one or more data |
| subsystem 212 | associated with at least one of: the one or more electronic mails |
| | and the one or more electronic documents attached in the one |
| | or more electronic mails. |
| Payment | The payment information feature determining subsystem 214 is |
| information | configured to determine the one or more payment information |
| feature | features for the one or more information tokens by analyzing |
| determining | the one or more contexts of the one or more information tokens |
| subsystem 214 | extracted from at least one of: the one or more electronic mails |
| | and the one or more electronic documents in the one or |
| | electronic mails. |
| Token | The token selection subsystem 216 is configured to select the |
| selection | one or more optimum information tokens by analyzing the |
| subsystem 216 | determined one or more payment information features by the |
| | one or more parameter-driven pre-configured rules. |
| Payment | The payment information determining subsystem 218 is |
| information | configured to determine the one or more first payment |
| determining | information including at least one of: the one or more payment |
| subsystem 218 | amounts and the one or more payment identifiers within at least |
| | one of: the one or more electronic mails and the one or more |
| | electronic documents, for the one or more optimum information |
| | tokens by the machine learning model. |
| Output | The output subsystem 220 is configured to provide the output |
| Subsystem 220 | of the determined one or more first payment information |
| | comprising at least one of: the one or more payment amounts |
| | and the one or more payment identifiers to the one or more users |
| | on the user interface associated with the one or more electronic |
| | devices 102. |
| Training | The training subsystem 222 is configured to re-train the |
| subsystem 222 | machine learning model over a plurality of time intervals with |
| | one or more training data. |

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The plurality of subsystems 110 includes the data receiving subsystem 210 that is communicatively connected to the one or more hardware processors 204. The data receiving subsystem 210 is configured to receive the one or more data from the one or more databases 108. The one or more data include at least one of: the one or more electronic mails and the one or more electronic documents attached in the one or more electronic mails. In an embodiment, the one or more electronic mails received from the one or more databases 108, may include at least one of: a plain text file format (EML format) commonly used for storing single email messages, a Microsoft Outlook-specific binary format (MSG format) for individual email messages, a format (e.g., MBOX format) for storing multiple email messages as plain text files in a concatenated format, a database format (e.g., EDB format) used by Microsoft Exchange Server to store mailbox data, a format (e.g., EMLX format) employed by Apple Mail for individual email messages, each stored as a separate file, and the like.

In an embodiment, the one or more electronic mails may include the one or more electronic documents (e.g., one or more remittance documents). The one or more electronic mails may include the one or more remittance documents in one or more formats. For example, the one or more formats may include at least one of: one or more scanned documents, one or more scanned images, one or more image files including at least one of: Joint Photographic Experts Group (JPEG) files, Portable Network Graphics (PNG) files, Graphics Interchange Format files, and the like. Additionally, the ML-based computing system 104 extends its capabilities to process at least one of: one or more Portable Document Format (PDF) files, one or more text files including Word files and Notepad files, one or more spreadsheet files (e.g., Excel files), and the like.

In an embodiment, the one or more databases 108 may include a range of databases and one or more data sources from which the one or more electronic mails and the one or more electronic documents are received. The one or more databases 108 may include at least one of: local file systems, network shares, cloud storage services, FTP servers, document management systems, content management systems, email servers, relational database systems, and the like. In another embodiment, the one or more databases 108 may further extend its reach to web services and application programming interfaces (APIs), enabling the retrieval of the one or more electronic documents from online data sources. Additionally, the data receiving subsystem 210 is configured to provide the capability to access the one or more electronic documents obtained through at least one of: document repositories, blockchain-based databases, legacy systems, and the like. In certain other embodiments, the email receiving subsystem 210 is configured to offer integration with at least one of: external storage devices, mobile devices, cloud-based collaboration tools, data warehouses, custom data sources, proprietary systems, and the like.

The plurality of subsystems 110 further includes the token extraction subsystem 212 that is communicatively connected to the one or more hardware processors 204. The token extraction subsystem 212 is configured to extract the one or more information tokens from the one or more data associated with at least one of: the one or more electronic mails and the one or more electronic documents attached in the one or more electronic mails. For extracting the one or more information tokens from the one or more data, the token extraction subsystem 212 is initially configured to convert the one or more data associated with at least one of: the one or more electronic mails and the one or more electronic documents to one or more text formats, based on at least one of: an industry standard parser process and an industry standard conversion process.

In an embodiment, the industry standard parser process is used for extracting the relevant information from a header and a body of the one or more electronic mails including at least one of: a sender, a recipient, a subject, date, a message content, and the like. A parser is configured to handle one or more encodings and one or more character sets that are used in the one or more electronic mails. The parser is further configured to output the extracted information in a text format, using at least one of: a predefined template and a custom template.

In another embodiment, a converter in the industry standard conversion process is configured to read the content of the one or more electronic mails and the one or more electronic documents and convert the one or more electronic mails and the one or more electronic documents to text format. The converter is configured to handle different types of content in the one or more electronic mails and the one or more electronic documents, including at least one of: images, tables, graphs, fonts, and the like. The converter is configured to output the converted content in a text format, using at least one of: a predefined template and a custom template.

The token extraction subsystem 212 is further configured to transform the one or more text formats into the one or more information tokens, based on a tokenization process. The token extraction subsystem 212 is configured to obtain the converted one or more text formats from the one or more electronic mails and the one or more electronic documents and transform the one or more text formats into smaller, discrete units known as the one or more information tokens. The one or more information tokens are fundamental building blocks for subsequent analysis and data extraction. In an embodiment, The token extraction subsystem 212 is configured to utilize tokenization that is a process of breaking down the continuous text into individual units, which may be at least one of: words, phrases, and other meaningful chunks. The tokenization process is carried out using one or more techniques including whitespace-based splitting, linguistic analysis, regular expressions, and the like.

In certain embodiments, depending on the system's configuration, different types of information tokens may be created. The one or more information tokens may include at least one of: one or more word tokens, one or more phrase tokens, one or more numeric tokens, and the like. As an example, the one or more word tokens represent individual words in the text. The one or more phrase tokens represent multi-word expressions. For example, “Automated Clearing House” could be a single token rather than three separate words. The one or more numeric tokens including dates, quantities, and currency amounts, are isolated as the one or more information tokens.

The plurality of subsystems 110 further includes the payment information feature determining subsystem 214 that is communicatively connected to the one or more hardware processors 204. The payment information feature determining subsystem 214 is configured to determine the one or more payment information features for the one or more information tokens by analyzing the one or more contexts of the one or more information tokens extracted from at least one of: the one or more electronic mails and the one or more electronic documents attached in the one or electronic mails. In an embodiment, the determined one or more payment information features are configured to determine whether the one or more information tokens include one or more contents related to the one or more first payment information. In an embodiment, the one or more first payment information may include at least one of: the one or more payment amounts and the one or more payment identifiers.

In an embodiment, the one or more payment amounts are critical components of the one or more remittance documents, providing essential information about a monetary value being transferred from one party to another. The one or more payment amounts are numerical representations of funds involved in a financial transaction, typically expressed in the currency of the transaction. In an embodiment, the one or more payment identifiers are also the critical components of the one or more remittance documents that serve the purpose of uniquely identifying a specific payment or transaction, the one or more payment identifiers are designed to facilitate the tracking, processing, and reconciliation of payments among one or more parties involved in one or more financial systems.

In an embodiment, the one or more payment information features may include at least one of: horizontal distance from one or more first payment keywords (e.g., payment keywords), vertical distance from the one or more first payment keywords, horizontal distance from one or more second payment keywords (e.g., non-payment keywords), vertical distance from the one or more second payment keywords, one or more zip codes, recurrence of the one or more information tokens, and one or more positions of the one or more information tokens in a remittance page.

The one or more first payment keywords (e.g., the payment keywords) may include at least one of: payment, check, electronic fund transfer (EFT), remittance, paid, advice, automated clearing house (ACH), transfer, total, sum, due, total, deposit, net, and the like. In an embodiment, the one or more first payment keywords for identification of the one or more payment identifiers include at least one of: the payment, the check, the EFT, the remittance, the paid, the advice, the ACH, the transfer, and the like. In an embodiment, the one or more first payment keywords for identification of the one or more payment amounts include at least one of: the payment, the total, the check, the sum, the due, the total, the deposit, the net, and the like.

The one or more second payment keywords (e.g., the non-payment keywords) may include at least one of: vendor, date, post office box (P.O. box), discount, page, phone, telephone number (tel) and the like. In an embodiment, the horizontal distance from the one or more first payment keywords is configured to determine the minimum horizontal distance between any instance of the one or more payment keywords (e.g., “payment,” “check,” “EFT”) and the one or more first payment information (one or more payment amounts and the one or more payment identifiers) when they are present in the same row. For example, if the word “payment” and a payment amount are in the same row, the horizontal distance would be 0.

In an embodiment, the vertical distance from the one or more first payment keywords is configured to determine the minimum vertical distance between any occurrence of the one or more payment keywords and a numeric value when they are located in different rows. For example, if “payment” and a payment amount are in different rows but share the same column, the vertical distance would be 0. In an embodiment, the horizontal distance from the non-payment keywords is configured to determine the minimum horizontal distance, but between the non-payment keywords and numeric values when they are in the same row. In an embodiment, the vertical distance from the non-payment keywords is configured to determine the vertical distance between the non-payment keywords and the numeric values when they are in different rows.

In an embodiment, the one or more zip codes is configured to determine whether a given numeric value corresponds to a zip code. The one or more zip codes likely use a pattern-matching or validation algorithm to identify zip code patterns, including 5 or 9-digit numerical sequences with optional hyphens. In an embodiment, the recurrence (frequency) of the one or more information tokens is configured to determine the frequency of a specific information token (e.g., a word or sequence of characters) within the entire electronic mail content. The recurrence (frequency) of the one or more information tokens likely involve the tokenization process of the text and counting the occurrences of the target information token.

In an embodiment, the one or more positions of the one or more information tokens are configured to determine a position of the information token in a page. For this, the payment information feature determining subsystem 214 is configured to divide a page into three parts including at least one of: top, middle, and bottom. The payment information feature determining subsystem 214 is further configured to determine the position of a numeric value within these parts. For example, a numeric value determined in the top part may be classified as a “payment number,” one in the middle as “invoice details,” and one in the bottom as “payment amount.”

The plurality of subsystems 110 further includes the token selection subsystem 216 that is communicatively connected to the one or more hardware processors 204. The token selection subsystem 216 is configured to select the one or more optimum information tokens by analyzing the determined one or more payment information features by the one or more parameter-driven pre-configured rules. For selecting the one or more optimum information tokens (e.g., one or more potential information tokens), the token selection subsystem 216 is configured to use the one or more parameter-driven pre-configured rules based on semantic analysis of the one or more payment keywords and the one or more non-payment keywords. Additionally, the parameter-driven pre-configured rules may also use the determined one or more payment information features to select the one or more optimum information tokens.

As a non-limiting example, if the payment information feature determining subsystem 214 identifies a keyword “payment” and a number with horizontal distance from the “payment” as 0, then the token selection subsystem 216 is configured to select identified keyword “payment” as an optimum information token since there is a high probability that a number adjacent to the keyword “payment” may represent a payment amount. As another non-limiting example, if the payment information feature determining subsystem 214 identifies a keyword “invoice number” and a text with horizontal distance from the “invoice number” as 0, then the token selection subsystem 216 is configured to select the identified keyword “invoice number” as an optimum information token since there is a high probability that a number adjacent to the keyword “invoice number” may represent a payment identifier.

The plurality of subsystems 110 further includes the payment information determining subsystem 218 that is communicatively connected to the one or more hardware processors 204. The payment information determining subsystem 218 is configured to determine the one or more first payment information including at least one of: the one or more payment amounts and the one or more payment identifiers within at least one of: the one or more electronic mails and the one or more electronic documents, for the one or more optimum information tokens by the machine learning model. In an embodiment, the machine learning model may be a random forest model, which is a tree-based model.

For determining the one or more first payment information including at least one of: the one or more payment amounts and the one or more payment identifiers within at least one of: the one or more electronic mails and the one or more electronic documents, for the one or more optimum information tokens, the payment information determining subsystem 218 is configured to generate one or more confidence scores for the one or more optimum information tokens. In an embodiment, the one or more confidence scores for the one or more optimum information tokens indicate quantitative measure of the one or more first payment information including at least one of: the one or more payment amounts and the one or more payment identifiers, available in the one or more optimum information tokens.

The one or more confidence scores are generated for the one or more optimum information tokens based on at least one of: the determined one or more payment information features and one or more first weights assigned to the one or more payment information features based on the availability of the one or more first payment information including at least one of: the one or more payment amounts and the one or more payment identifiers in the one or more optimum information tokens.

The payment information determining subsystem 218 is further configured to label the one or more optimum information tokens to classify, the one or more optimum information tokens into at least one of: the one or more payment amounts, the one or more payment identifiers and one or more non-payment information, based on the one or more confidence scores generated for the one or more optimum information tokens by one or more predetermined threshold values. The one or more non-payment information (e.g., irrelevant information) are distinct from the one or more first payment information.

In an embodiment, the one or more optimum information tokens are classified as the one or more non-payment information (e.g., the irrelevant information) when the one or more confidence scores for the one or more payment amounts and the one or more payment identifiers, are within the one or more predetermined threshold values. In an embodiment, the one or more predetermined threshold values may be 0.8. In a non-limiting example, if the one or more confidence scores for the one or more payment identifiers is 0.6 and the one or more confidence scores for the one or more payment amounts is 0.7 for a particular information token, the payment information determining subsystem 218 is configured to classify that specific information token as “Irrelevant”.

In an embodiment, the one or more optimum information tokens are classified as the one or more payment amounts when at least one of: the one or more confidence scores for the one or more payment amounts are at least one of: equal and exceed the one or more predetermined threshold values, and the one or more confidence scores for the one or more payment identifiers are within the one or more predetermined threshold values. In a non-limiting example, if the one or more confidence scores for the one or more payment identifiers is 0.6, and the one or more confidence scores for the one or more payment amounts is 0.9, then the payment information determining subsystem 218 is configured to classify would prioritize the higher confidence score. Therefore, in this case, the payment information determining subsystem 218 is configured to classify that specific information token as “payment amount” since the one or more confidence scores for the one or more payment amounts (0.9) is greater than the one or more confidence scores for the one or more payment identifiers (0.6).

In an embodiment, the one or more optimum information tokens are classified as the one or more payment identifiers when at least one of: the one or more confidence scores for the one or more payment identifiers are at least one of: equal and exceed the one or more predetermined threshold values, and the one or more confidence scores for the one or more payment amounts are within the one or more predetermined threshold values. In a non-limiting example, if the one or more confidence scores for the one or more payment identifiers is 0.9, and the one or more confidence scores for the one or more payment amounts is 0.7, then the payment information determining subsystem 218 is configured to classify would prioritize the higher confidence score. Therefore, in this case, the payment information determining subsystem 218 is configured to classify that specific information token as “payment identifier” since the one or more confidence scores for the one or more payment identifiers (0.9) is greater than the one or more confidence scores for the one or more payment amounts (0.7).

In an embodiment, the one or more optimum information tokens are classified as at least one of: the one or more payment amounts and the one or more payment identifiers, based on one or more first optimum confidence scores generated for at least one of: the one or more payment amounts and the one or more payment identifiers, when at least one of: the one or more confidence scores for the one or more payment identifiers and the one or more payment amounts are at least one of: equal and exceed the one or more predetermined threshold values. In a non-limiting example, if the one or more confidence scores for the one or more payment identifiers is 0.9 and the one or more confidence scores for the one or more payment amounts is 0.8, then the payment information determining subsystem 218 is configured to consider both confidence scores. In this case, since both the confidence scores for the one or more payment identifiers and payment amounts are equal to or greater than 0.8, the payment information determining subsystem 218 is configured to prioritize the higher confidence score, which is 0.9 for the one or more payment identifiers. Therefore, the payment information determining subsystem 218 is configured to classify that specific information token as “payment identifier.”

The payment information determining subsystem 218 is further configured to classify the one or more optimum information tokens with one or more second optimum confidence scores (e.g., highest confidence scores) related to the one or more payment amounts, as one or more optimum payment amounts, upon the one or more confidence scores related to the one or more payment amounts are generated for the one or more optimum information tokens. In this step, the payment information determining subsystem 218 is configured to identify/determine the information token with the highest Payment amount confidence score and classify the information token as the one or more payment amounts.

The payment information determining subsystem 218 is further configured to classify the one or more optimum information tokens with one or more third optimum confidence scores (e.g., highest confidence scores) related to the one or more payment identifiers, as one or more optimum payment identifiers, upon the one or more confidence scores related to the one or more payment identifiers are generated for the one or more optimum information tokens. In this step, the payment information determining subsystem 218 is configured to identify/determine the information token with the highest Payment amount confidence score and classify the information token as the one or more payment identifiers. In a non-limiting example, the information tokens include the following confidence scores:

| | Payment Amount | Payment Identifier |
|---|---|---|
| | Confidence Score | Confidence Score |
| Information | 0.75 | 0.85 |
| Token 1 | | |
| Information | 0.88 | 0.78 |
| Token 2 | | |
| Information | 0.81 | 0.92 |
| Token 3 | | |

Following the generation of the one or more confidence scores, the payment information determining subsystem 218 is configured to identify an information token 3 as the one with the highest confidence score of 0.92 under the payment identifier and consequently classify the information token 3 as “payment identifier.” Furthermore, the payment information determining subsystem 218 is configured to identify an information token 2 as the one with the highest confidence score of 0.88 under the payment amount and consequently classify the information token 3 as “payment amount.”

In a non-limiting example, the information tokens includes the following confidence scores:

| | Payment Amount | Payment Identifier |
|---|---|---|
| | Confidence Score | Confidence Score |
| Information | 0.72 | 0.94 |
| Token A | | |
| Information | 0.96 | 0.82 |
| Token B | | |
| Information | 0.88 | 0.76 |
| Token C | | |

Following the generation of the one or more confidence scores, the payment information determining subsystem 218 is configured to identify an information token B as the one with the highest confidence score of 0.96 under the payment amount and consequently classify the information token B as “payment amount.” Furthermore, the payment information determining subsystem 218 is configured to identify an information token A as the one with the highest confidence score of 0.94 under the payment identifier and consequently classify the information token A as “payment identifier.”

The plurality of subsystems 110 further includes a manual mapping subsystem that is communicatively connected to the one or more hardware processors 204. The manual mapping subsystem is configured to address and manage discrepancies or anomalies that may arise during the process of the payment information determining subsystem 218. The discrepancies may include scenarios where the one or more payment amounts and the one or more payment identifiers cannot be identified by the payment information determining subsystem 218. The manual mapping subsystem is further configured to detect and flag the one or more electronic mails and the one or more electronic documents that exhibit the aforementioned discrepancies. When such discrepancies are identified, the manual mapping subsystem is configured to mark the documents for manual review and resolution. This flagging mechanism ensures that a human analyst can intervene to rectify the discrepancies and ensure accurate reconciliation.

In an embodiment, the manual mapping subsystem is configured to enable seamless integration of human intervention within the automated payment information identification process. The manual mapping subsystem is configured to allow the one or more users to review and resolve discrepancies promptly. The manual mapping subsystem is configured to provide a user-friendly interface through which the one or more users can access and address emails and email attachments marked for manual review. In optional embodiments, the manual mapping subsystem is configured to generate detailed logs and reports regarding the documents that have been flagged for manual review. The detailed logs serve as a record of the actions taken during the resolution process, providing transparency and traceability within the ML-based computing system 104.

The plurality of subsystems 110 further includes the output subsystem 220 that is communicatively connected to the one or more hardware processors 204. The output subsystem 220 is configured to provide the output of the determined one or more first payment information including at least one of: the one or more payment amounts and the one or more payment identifiers to one or more users on the user interface associated with the one or more electronic devices 102. In an embodiment, the output subsystem 220 is further configured to update database records pertaining to the one or more payment amounts and the one or more payment identifiers.

The plurality of subsystems 110 further includes the training subsystem 222 that is communicatively connected to the one or more hardware processors 204. The training subsystem 222 is configured to train the machine learning model. For training the machine learning model, the training subsystem 222 is configured to obtain one or more labelled datasets from the one or more databases 108. The one or more labelled datasets include the one or more information tokens extracted from at least one of: the one or more electronic mails and the one or more electronic documents attached in the one or more electronic mails. The training subsystem 222 is further configured to select one or more features vectors associated with the one or more payment information features for training the machine learning model based on a feature engineering process. In an embodiment, the machine learning model may include a random forest based machine learning model.

The training subsystem 222 is further configured to label the one or more optimum information tokens to classify the one or more optimum information tokens into at least one of: the one or more payment amounts, the one or more payment identifiers and the one or more non-payment information. The training subsystem 222 is further configured to segment the one or more labelled datasets into at least one of: one or more training datasets and one or more validation datasets. The training subsystem 222 is further configured to train the machine learning model to correlate the one or more feature vectors associated with the one or more payment information features, with at least one of: the one or more payment amounts and the one or more payment identifiers, based on one or more hyperparameters.

In an embodiment, the one or more hyperparameters may include at least one of: max_depth, class_weight, n_estimators, min_samples_split, max_features, and min_samples_leaf. The max_depth hyperparameter is configured to control an optimum depth of each decision tree in the random forest based machine learning model. The class_weight hyperparameter is configured to adjust one or more second weights of one or more classes in the random forest based machine learning model to control one or more class imbalance errors. The n_estimators hyperparameter is configured to indicate a number of one or more decision trees to be included in the random forest based machine learning model.

The min_samples_split hyperparameter is configured to set a pre-determined number of one or more data points required in a node before the one or more data points split during a tree-building process. The max_features hyperparameter is configured to determine an optimum number of the one or more payment information features when the optimum split of the one or more payment information features at each node in the random forest based machine learning model. The min_samples_leaf is configured to indicate the pre-determined number of one or more data points required to generate a leaf node during the tree-building process.

The training subsystem 222 is further configured to generate the one or more confidence scores for the one or more optimum information tokens, based on the trained machine learning model. The training subsystem 222 is further configured to validate the machine learning model based on the one or more validation datasets. For validating the machine learning model based on the one or more validation datasets, the training subsystem 222 is configured to determine whether one or more metric scores attained by the trained machine learning model, exceeds one or more pre-determined threshold values. The one or more metric scores are associated with one or more validation metrics including at least one of: precision metric, recall metric, F1-score metric, and confusion metric.

The training subsystem 222 is further configured to adjust the one or more hyperparameters to fine-tune the machine learning model based on one or more results of validation of the machine learning model. The training subsystem 222 is further configured to re-train the machine learning model over a plurality of time intervals based on one or more training data. For re-training the machine learning model over the plurality of time intervals, the training subsystem 222 is configured to receive the one or more training data associated with at least one of: the one or more electronic mails and the one or more electronic documents attached in the one or more electronic mails.

The training subsystem 222 is further configured to add the one or more training data with the one or more training datasets to generate one or more updated training datasets. The training subsystem 222 is further configured to re-train the machine learning model to correlate the one or more feature vectors associated with the one or more payment information features, with at least one of: the one or more payment amounts and the one or more payment identifiers. In an embodiment, the one or more confidence scores are generated based on re-training the machine learning model. The training subsystem 222 is further configured to execute the re-trained machine learning model in the payment information determining subsystem 218 to determine the one or more first payment information including at least one of: the one or more payment amounts and the one or more payment identifiers within at least one of: the one or more electronic mails and the one or more electronic documents.

Subsequently, the same training process is followed which includes continuous evaluation and tuning to assess the quality of the mappings and iteratively improving the results if necessary. The steps are repeated for a fixed number of iterations until the ML-based computing system 104 can identify the one or more payment amounts and the one or more payment identifiers with sufficient accuracy. Thereafter, the changes are implemented to the payment information determining subsystem 218, and new identifications take place with an updated module.

FIG. 3 is an overall process flow 300 of determining the one or more payment information from the one or more electronic mails, in accordance with another embodiment of the present disclosure. At step 302, the one or more data associated with at least one of: the one or more electronic mails and the one or more electronic documents attached in the one or more electronic mails, are received from the one or more databases 108. The one or more databases 108 may include at least one of: the one or more internal databases and the one or more external databases.

The data receiving subsystem 210 is configured to connect the one or more internal databases, which may store the one or more electronic mails sent and received within the organization. The one or more internal databases maintain a historical record of communications. In an embodiment, the one or more extremal databases may include one or more repositories outside the organization's network. The one or more external databases may be at least one of: cloud-based storage services, document management systems, content management systems, electronic mail servers, relational database systems, and the like. The one or more external databases extend reach beyond organizational boundaries of the ML-based computing system 104. In another embodiment, at step 302, the data receiving subsystem 210 goes beyond traditional databases to interact with web services and APIs, enabling it to retrieve the one or more electronic mails and one or more attachments (e.g., the one or more electronic documents) from online data sources. This capability allows the data receiving subsystem 210 to tap into real-time data feeds and external platforms.

In yet another embodiment, at step 302, the data receiving subsystem 210 is configured to access the one or more electronic documents stored in the one or more repositories, which can be hosted on one or more platforms. The one or more repositories may include digital libraries, archives, specialized document storage systems, and the like. In yet another embodiment, the data receiving subsystem 210 is configured to employ secure and efficient communication protocols to retrieve the one or more electronic mails and the one or more attachments from these diverse sources. The data receiving subsystem 210 is configured to use standard electronic mail protocols (e.g., IMAP, POP3) to collect the one or more electronic mails from one or more electronic mail servers, while employing one or more data transfer methods (e.g., HTTP, FTP) to access the one or more documents from the one or more repositories.

In another embodiment, when interacting with cloud storage services, the data receiving subsystem 210 is configured to connect securely to cloud platforms including at least one of: Amazon Web Services (AWS), Google Cloud Platform (GCP), Microsoft Azure, and the like. The data receiving subsystem 210 is further configured to leverage authentication mechanisms and access tokens to ensure data security and integrity. In another embodiment, data validation mechanisms may be implemented to ensure the integrity and authenticity of the retrieved one or more electronic mails and the one or more attachments. The data receiving subsystem 210 is configured to verify digital signatures, check for tampering, and confirm that the one or more data are complete and unaltered during transit. In yet another embodiment, to maintain transparency and traceability, the data receiving subsystem 210 is configured to log each interaction and data retrieval event. The logs serve as a record of activities, allowing organizations to monitor the flow of data and investigate any anomalies or issues that may arise. In yet another embodiment, robust error-handling mechanisms are in place to manage situations where data retrieval encounters issues, including at least one of: connectivity problems, data unavailability, access restrictions, and the like. The data receiving subsystem 210 is configured to queue and retry failed retrieval attempts and notify administrators of critical errors.

In yet another embodiment, security measures are paramount during step 302 to protect sensitive email content and attachments. Data encryption, access controls, and user authentication are enforced to safeguard against unauthorized access or data breaches. In yet another embodiment, the data receiving subsystem 210 is configured to process the one or more data associated with the one or more electronic mails and the one or more attachments in real-time as the one or more data are received or batch-process larger sets of historical data.

At step 304, the one or more information tokens are extracted from the one or more data associated with the one or more electronic mails and the one or more electronic documents attached in the one or more electronic mails. The one or more information tokens are extracted from the one or more data by converting the one or more data associated with at least one of: the one or more electronic mails and the one or more electronic documents to one or more text formats, as in step 306. In an embodiment, the one or more electronic mails typically include one or more components, including sender's information, recipient details, subject line, date and time stamp, and actual message body. Further, the one or more electronic documents attached in the one or more electronic mails are identified. The one or more electronic documents (e.g., the one or more attachments) may be in one or more formats including at least one of: images, portable document formats (PDFs), Word documents, spreadsheets, and the like. The token extraction subsystem 212 is configured to recognize and differentiate these attachments to determine appropriate conversion methods.

In another embodiment, once the electronic mail content and attachments are identified, the token extraction subsystem 212 is configured to employ format detection mechanisms. The token extraction subsystem 212 is configured to analyze the file extensions, MIME types, and content headers to ascertain the format of each attachment. This is crucial for selecting the correct conversion approach. In another embodiment, the token extraction subsystem 212 is configured to employ various methods including at least one of: the industry standard conversion process and the industry standard parser process, for converting different attachment formats into text formats. In certain embodiments, for attachments containing textual data, including at least one of: Word documents, Notepad files, or plain text emails (EML format), a straightforward text extraction method using a parser is applied. The parser extracts the text content, preserving the document's structure and formatting when applicable. In other embodiments, when dealing with scanned documents or images, the token extraction subsystem 212 is configured to utilize OCR technology to recognize and convert image-based text into machine-readable text. This process involves character recognition, layout analysis, and text reconstruction to ensure accuracy.

In certain other embodiments, in the case of complex attachment formats including HyperText Markup Language (HTML) and Extensible Markup Language (XML), the token extraction subsystem 212 is configured to parse the content to extract relevant text while discarding markup and formatting code. This ensures that only meaningful text data is retained. In another embodiment, for binary formats including Microsoft Outlook-specific (MSG), the token extraction subsystem 212 is configured to decode the binary data into a readable text representation. This requires understanding the structure of the binary format to extract the content of the one or more electronic mails. In another embodiment, in cases where the one or more attachments include images and graphical elements, the token extraction subsystem 212 is configured to perform image-to-text conversion. An optical character recognition (OCR) technology is applied to recognize text within images and convert the one or more attachments into machine-readable text.

In another embodiment, the token extraction subsystem 212 is configured to maintain the relationships between the content of the one or more electronic mails and its associated attachments. The token extraction subsystem 212 is configured to ensure that the text extracted from the one or more attachments is linked to the corresponding electronic mail, allowing for contextual analysis. In another embodiment, while the primary focus is on extracting the text, the token extraction subsystem 212 is configured to retain metadata including at least one of: sender and recipient information, subject lines, and timestamps. This metadata can be crucial for later analysis and reference.

In another embodiment, when processing multi-page documents or the one or more electronic mails with the one or more attachments, the token extraction subsystem 212 is configured to retain an original file structure. The token extraction subsystem 212 is configured to distinguish between different parts of the one or more electronic mails and the one or more attachments and to ensure that the content is organized for further analysis. The token extraction subsystem 212 is configured to serve as a bridge between raw electronic mail data and structured, machine-readable text. The token extraction subsystem 212 is configured to perform the extraction, transformation, and preservation of content from the one or more electronic mails and one or more attachment formats, enabling subsequent analysis and data extraction steps in the ML-based computing system 104. The conversion process is versatile, accommodating a wide range of attachment types and ensuring the integrity of the converted text data.

At step 308, the one or more text formats are converted into the one or more information tokens, based on the tokenization process. In certain embodiments, at step 308, the token extraction subsystem 212 is configured to address special cases that may arise during the tokenization process. The special cases may include handling electronic mail addresses, uniform resource locator (URLs), and one or more codes or identifiers that may need to be treated as single information tokens to preserve their integrity. In another embodiment, the one or more information tokens may be varied in length, from single characters to entire sentences. The token extraction subsystem 212 is configured to define token length boundaries to ensure that the one or more information tokens are manageable for analysis and do not become overly fragmented or excessively long. In certain embodiments, as the one or more information tokens are generated, the one or more information tokens may be indexed to maintain their original order in the text. This indexing aids in retaining the context of the one or more information tokens within the original electronic document.

In certain embodiments, alongside the tokenization process, metadata related to the text may be preserved. The metadata may include information about the source document, a location, and timestamps. The metadata may be useful for tracing the origin of the one or more information tokens. In certain embodiments, the token extraction subsystem 212 is configured to implement filters to exclude certain information tokens based on criteria including at least one of: token length, frequency, relevance, and the like, which help in reducing noise and focusing on meaningful information. In one embodiment, transformation of the one or more text formats into the one or more information tokens is a critical preprocessing step that transforms raw text from the one or more electronic mails and the one or more attachments into manageable information tokens. The one or more information tokens are the foundation for subsequent data analysis, including the computation of payment information features and the identification of payment-related content. The tokenization process involves one or more techniques including contextual analysis, and error handling to ensure the meaningful representation of text data.

At step 310, one or more payment information features are determined for the one or more information tokens by analyzing the one or more contexts of the one or more information tokens extracted from at least one of: the one or more electronic mails and the one or more electronic documents attached in the one or electronic mails. The one or more payment information features are configured to determine whether the one or more information tokens include the one or more contents related to the one or more first payment information. The one or more first payment information may include at least one of: the one or more payment amounts and the one or more payment identifiers. In other words, the one or more payment information features are specific characteristics or attributes that are indicative of whether a given information token may include payment-related content. The one or more payment information features are carefully chosen to capture relevant patterns and relationships in the text data.

In an embodiment, for each information token, the payment information feature determining subsystem 214 is configured to determine the one or more payment information features by analyzing its context within the one or more electronic mails and the one or more electronic documents attached in the one or electronic mails. For instance, the payment information feature determining subsystem 214 is configured to determine whether a payment keyword appears nearby, computes distances, counts token occurrences, and checks for zip code patterns. In another embodiment, based on the values of the one or more payment information features, the payment information feature determining subsystem 214 is configured to assign one or more scores to each information token. The one or more scores reflect the token's likelihood of containing one or more first payment information. The one or more information tokens with higher scores are considered more indicative of payment content.

In yet another embodiment, the payment information feature determining subsystem 214 is configured to establish thresholds or confidence levels to classify the one or more information tokens as having a high, medium, or low likelihood of containing one or more first payment information. These thresholds are determined based on training data and can be adjusted as needed for optimal performance. In certain embodiments, at step 310, the payment information feature determining subsystem 214 is configured to assess the relevance of each information token in relation to payment-related content. By determining a range of the one or more payment information features, the payment information feature determining subsystem 214 is configured to assess which tokens are likely to contain the one or more first payment information.

In certain embodiments, the one or more payment information features are carefully selected and designed to capture one or more aspects of the text data, including the spatial arrangement of payment-related information, keyword presence, and the frequency of specific tokens. The determination of the one or more payment information features provides a quantitative measure of the token's relevance to the one or more first payment information, aiding in the subsequent identification process. As an example, the horizontal and vertical distance features help assess how closely payment-related keywords or numeric values are located within the electronic document. A small distance value suggests a strong correlation between the token and payment content, while a larger distance may indicate less relevance.

As another non-limiting example, the one or more zip codes (zip code detection feature) is especially valuable for recognizing payment-related information, as the one or more zip codes are often associated with financial transactions. By identifying patterns that resemble the one or more zip codes, the payment information feature determining subsystem 214 is configured to flag the one or more information tokens as potentially containing payment data. As another non-limiting example, the token frequency determination provides insights into the token's significance within the electronic document. The one or more information tokens that appear frequently are more likely to be relevant to payment content, as one or more information tokens may indicate repeated references to the financial transactions.

As another non-limiting example, the position of the one or more information tokens within the remittance page is crucial for understanding the context of numeric values. For instance, a number appearing at the top of a page may be more likely to be a payment identifier, while one at the bottom may be a payment amount. This spatial awareness helps refine the system's identification process. In another embodiment, the payment and non-payment keywords serve as markers for relevant terms in the text. Identifying the payment and non-payment keywords near an information token can strongly influence its score, as certain words including “payment” or “check” are highly indicative of payment content.

At step 312, the one or more optimum information tokens are selected by analyzing the determined one or more payment information features by the one or more parameter-driven pre-configured rules. As a non-limiting example, if in step 312, the token selection subsystem 216 system identifies a payment keyword “total” or “sum” and a number with horizontal distance from the “total” or “sum” as 0, the keyword “total” or “sum” may be selected as a potential information token since there is a high probability that a number adjacent to the keyword “total” or “sum” may represent a payment amount. As another non-limiting example, if in step 312, the token selection subsystem 216 system identifies a payment keyword “payment” and a text with horizontal distance from the “payment” as 0, the keyword “payment” may be selected as a potential information token since there is a high probability that a text adjacent to the keyword “payment” may represent a payment identifier. The one or more first payment keywords (e.g., the payment keywords) may include at least one of: payment, check, electronic fund transfer (EFT), remittance, paid, advice, automated clearing house (ACH), transfer, total, sum, due, total, deposit, net, and the like. In an embodiment, the one or more first payment keywords for identification of the one or more payment identifiers include at least one of: the payment, the check, the EFT, the remittance, the paid, the advice, the ACH, the transfer, and the like. In an embodiment, the one or more first payment keywords for identification of the one or more payment amounts include at least one of: the payment, the total, the check, the sum, the due, the total, the deposit, the net, and the like.

At step 314, the one or more confidence scores related to at least one of: the one or more payment amounts and the one or more payment identifiers, are generated for the one or more optimum information tokens. The one or more confidence scores for the one or more optimum information tokens indicate quantitative measure of the one or more first payment information including at least one of: the one or more payment amounts and the one or more payment identifiers, available in the one or more optimum information tokens. In an embodiment, the generation of the one or more confidence scores is feature-based, leveraging the one or more payment information features determined in step 310. The one or more payment information features include one or more metrics including horizontal and vertical distances from the payment keywords, the token frequency, the zip code patterns, and the presence of specific payment and non-payment keywords.

In another embodiment, the payment information determining subsystem 218 is configured to assign one or more weights to each payment information feature based on its importance and relevance in identifying the one or more payment identifiers and the one or more payment amounts. For example, proximity to payment keywords may carry a higher weight compared to the token frequency. In another embodiment, the payment information determining subsystem 218 is configured to generate the one or more confidence scores using mathematical models or machine learning algorithms. The payment information determining subsystem 218 is configured to combine the feature values and their associated weights to arrive at an overall score for each token. The formula for score computation can be fine-tuned through training and optimization processes.

In one embodiment, the payment information determining subsystem 218, in step 312, plays a pivotal role in categorizing each information token as a payment identifier, payment amount, or irrelevant (e.g., the non-payment information). The confidence scores provide a quantifiable measure of the token's relevance to payment-related content, helping guide a decision-making process. By combining feature-based analysis with carefully defined thresholds and rules, the payment information determining subsystem 218 can make informed judgments about the significance of each token, setting the stage for accurate identification in the subsequent steps of the ML-based computing system 104.

At step 316, the one or more optimum information tokens are labelled as the payment identifier, the payment amount and the non-payment information (e.g., the irrelevant payment) based on the generated one or more confidence scores. In certain embodiments, for cases where a token's confidence scores are close to the threshold or fall within a gray area, at least one of: additional rules and machine learning models may be employed to further assess the token's classification, which helps in mitigating potential ambiguities in labelling. The decision-making process relies on the one or more predefined thresholds and rules, as well as the token's assigned confidence scores. Accurate labelling is crucial for subsequent steps in the ML-based computing system 104, particularly in the identification and extraction of payment-related information from the one or more electronic mails and the one or more electronic documents attached in the one or more electronic mails.

At step 318, the one or more first payment information including the one or more payment amounts and the one or more payment identifiers, is determined within at least one of: the one or more electronic mails and the one or more electronic documents, for the one or more optimum information tokens, based on the one or more confidence scores assigned to the one or more information tokens. In another embodiment, for payment identifier identification, the payment information determining subsystem 218 is configured to select the information token with the highest confidence score for the payment identifier among the collected “payment identifier” information tokens. This information token is considered the most reliable candidate for representing the payment identifier. In yet another embodiment, in cases where multiple information tokens are labelled as “payment identifier,” the payment information determining subsystem 218 is configured to prioritize the one with the highest confidence score, providing a degree of confidence in the selection. The presence of multiple candidates may indicate variations in how payment identifiers are represented within the electronic document.

In yet another embodiment, in situations where the one or more confidence scores are very close or ambiguous, the payment information determining subsystem 218 is configured to employ additional rules and machine learning models to further assess and resolve the ambiguity. In yet another embodiment, similar to payment identifier selection, the payment information determining subsystem 218 is configured to choose the information token with the highest confidence score for the payment amount among the collected “payment amount” tokens. This information token represents the most reliable candidate for payment amount identification. In yet another embodiment, in cases where multiple information tokens are labelled as “payment amount,” the one with the highest confidence score takes precedence. The one or more candidates may indicate one or more representations of payment amounts within the electronic document. In another embodiment, ambiguities in payment amount identification are addressed similarly to those in payment identifier identification. The additional rules or machine learning models may be employed to resolve ambiguities when the one or more confidence scores are close.

In yet another embodiment, the one or more information tokens labelled as “irrelevant” are excluded from further consideration for payment identifier and payment amount identification, reducing noise in the final output. In one embodiment, step 318 involves a decision step. If the payment identifier and the payment amount are found (as shown in step 320), the method proceeds to step 324 for output. If either the payment identifier or the payment amount are not found (as shown in step 322), the method proceeds to step 326 for manual mapping. In an embodiment, the identification process may undergo iterative refinement through continuous evaluation and tuning. This ensures that the payment information determining subsystem 218 adapts to evolving data patterns and maintains high accuracy in identifying payment identifier and payment amount information.

In summary, step 318 represents the outcome of the ML-based computing system's 104 efforts to identify the payment identifier and payment amount within the electronic mail and its attachments. The payment information determining subsystem 218 is configured to rely on the one or more confidence scores and labels assigned to information tokens to make informed decisions about which information tokens serve as the most reliable representatives of these critical payment-related components.

At step 326, the manual mapping is initiated when the ML-based computing system 104 encounters situations where the ML-based computing system 104 cannot confidently identify the payment identifier and payment amount based solely on automated processes. In certain embodiments, common triggers for the manual mapping include ambiguities, missing information, complex electronic document structures and the like. As a non-limiting example, an ambiguity includes a scenario when the one or more confidence scores of potential payment identifier or payment amount tokens are very close, making it challenging to determine the correct choice automatically.

As a non-limiting example, an ambiguity includes a scenario when the ML-based computing system 104 cannot determine a suitable candidate for payment identifier or payment amount within the electronic document due to variations in document formats or lack of clear indicators. As a non-limiting example, an ambiguity includes a scenario when the electronic document structure is highly complex, making it difficult for the ML-based computing system 104 to accurately locate and identify the Payment identifier and payment amount.

In certain embodiments, tokens or documents that trigger the manual mapping are placed in a queue or flagged for human review. This queue can be accessed by the one or more users (e.g., the data analysts) or operators responsible for resolving discrepancies. In other embodiments, trained data analysts or operators access the queue to review the one or more information tokens or electronic documents that require the manual mapping. The role of the trained data analysts is to manually identify and map the payment identifier and payment amount based on their expertise and understanding of financial documents. In certain embodiments, the manual mapping subsystem is typically configured to provide a user-friendly interface through which the data analysts can access and review the flagged tokens or electronic documents. This interface may include features such as zooming in on specific parts of the electronic document, highlighting relevant information, and providing tools for annotation.

In other embodiments, the data analysts carefully review the electronic document to identify the payment identifier and payment amount. The data analysts may leverage their knowledge of financial documents, patterns, and context to make accurate determinations. Once identified, the payment identifier and payment amount are manually mapped and associated with their respective labels within the ML-based computing system 104. This mapping serves to align the manual identification with the automated process for future reference. In certain embodiments, once the manual mapping is completed, the identified payment identifier and payment amount are integrated back into the ML-based computing system's 104 workflow. This ensures that the manually verified information contributes to system learning and can be used to enhance future automated identification processes. In other embodiments, the manual mapping process can contribute to iterative system improvement. The insights gained from manual reviews may inform updates to the random forest machine learning models, reducing the need for manual intervention overtime.

In summary, the manual mapping subsystem, in step 326, introduces the data analysts into the ML-based computing system's 104 workflow to address discrepancies or complexities in identifying the payment identifier and payment amount. The trained data analysts play a crucial role in manually reviewing and mapping this information, ensuring accuracy and reliability in financial document processing. This step enhances the ML-based computing system's 104 ability to handle diverse document formats and challenging cases while contributing to continuous improvement efforts.

At step 324, the output for the determined payment identifier and the payment amount is provided on the user interface associated with the one or more electronic devices 102. The output subsystem 220 is configured to generate a structured output that includes the payment identifier and the payment amount. The one or more payment identifiers are identified and mapped from the electronic document. This typically includes details such as invoice numbers, transaction IDs, or any other unique identifiers associated with financial transactions. The one or more payment amounts are identified and mapped from the electronic document. This represents the monetary value involved in a financial transaction, often expressed in the currency of the transaction.

Optionally, the output subsystem 220 may include the one or more confidence scores associated with each mapped payment identifier and payment amount. The one or more confidence scores indicate the level of confidence in the accuracy of the identification and mapping. The one or more higher confidence scores reflect a higher degree of certainty in the results. The output subsystem 220 is configured to provide one or more outputs in one or more formats to cater to user needs. In one embodiment, the output is in the form of structured data formats. The one or more payment identifiers and the one or more payment amounts are provided in structured data formats, including JSON or XML, making the one or more payment identifiers and the one or more payment amounts easy for automated systems to ingest and process the information. In another embodiment, for the one or more users, a user-friendly interface is presented, displaying the identified one or more payment identifiers and the one or more payment amounts in a clear and organized manner. This interface may allow the one or more users to review and verify the results. In another embodiment, the outputs are designed for seamless integration with other systems, including at least one of: accounting application, enterprise resource planning (ERP) systems, financial databases, and the like. This integration streamlines the reconciliation and processing of financial data.

In summary, the output subsystem 220, in step 324, represents the final stage of the ML-based computing system's 104 workflow, where the identified and mapped one or more payment identifiers and the one or more payment amounts are delivered as structured outputs. These outputs are tailored to meet the needs of both automated systems and the one or more users, enabling seamless integration with financial processes and enhancing decision-making capabilities. The output subsystem 220 ensures data accuracy, security, and compliance while supporting continuous improvement efforts through user feedback and system refinement.

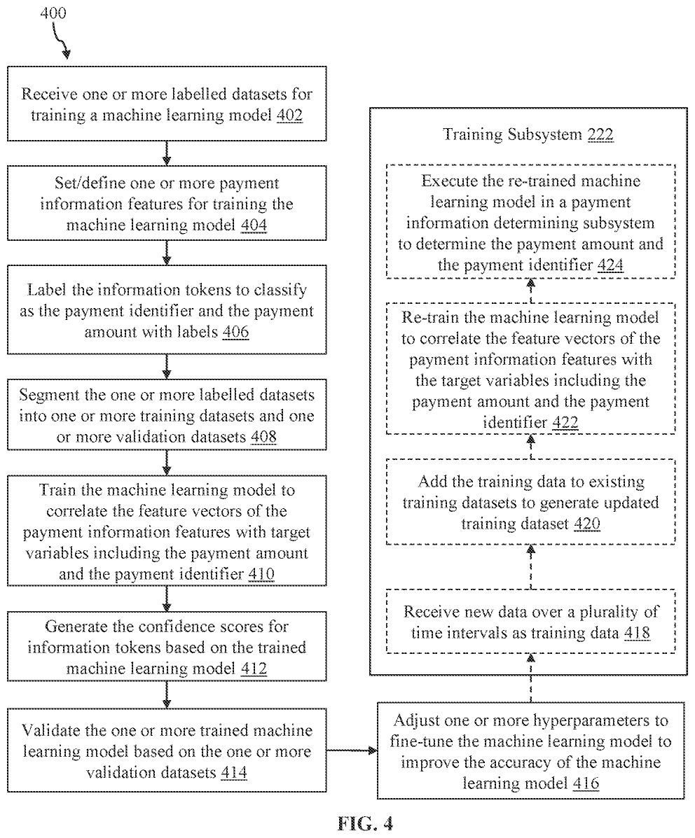

FIG. 4 is a process flow 400 of training the random forest based machine learning model for determining the one or more payment information from the one or more electronic mails, in accordance with an embodiment of the present disclosure. At step 402, the one or more labelled datasets with a diverse set of electronic mails and electronic mail attachments, are received. In an embodiment, the one or more labelled datasets may include the one or more information tokens extracted from at least one of: the one or more electronic mails and the one or more electronic documents attached in the one or more electronic mails.

At step 404, the one or more features vectors associated with the one or more payment information features are selected for training the machine learning model based on the feature engineering process. In an embodiment, the machine learning model is the random forest based machine learning model. At step 406, the one or more optimum information tokens are labelled to classify the one or more optimum information tokens into at least one of: the one or more payment amounts, the one or more payment identifiers and the one or more non-payment information (e.g., the irrelevant information), based on the one or more predetermined threshold values and parameters.

At step 408, the one or more labelled datasets are segmented/split into at least one of: the one or more training datasets and the one or more validation datasets. In a non-limiting embodiment, a 70/30 split is used for the one or more training datasets and the one or more validation datasets, respectively. In another non-limiting embodiment, a 80/20 split is used for the one or more training datasets and the one or more validation datasets, respectively.

At step 410, the machine learning model is trained to correlate the one or more feature vectors associated with the one or more payment information features, with at least one of: the one or more payment amounts and the one or more payment identifiers, based on one or more hyperparameters. In an embodiment, the one or more hyperparameters comprise at least one of: max_depth, class_weight, n_estimators, min_samples_split, max_features, and min_samples_leaf. At step 412, the one or more confidence scores are generated for the one or more optimum information tokens, based on the trained machine learning model.

At step 414, the machine learning model is validated based on the one or more validation datasets. In an embodiment, the machine learning model is validated by determining whether one or more metric scores attained by the trained machine learning model, exceeds one or more pre-determined threshold values. In an embodiment, the one or more metric scores are associated with one or more validation metrics including at least one of: the precision metric, the recall metric, the F1-score metric, confusion metric, and the like. At step 416, the one or more hyperparameters are adjusted to fine-tune the machine learning model based on one or more results of validation of the machine learning model.

At step 418, the one or more training data associated with at least one of: the one or more electronic mails and the one or more electronic documents attached in the one or more electronic mails, are received. At step 420, the one or more training data are added with the one or more training datasets to generate one or more updated training datasets. At step 422, the machine learning model is re-trained to correlate the one or more feature vectors associated with the one or more payment information features, with at least one of: the one or more payment amounts and the one or more payment identifiers. In an embodiment, the one or more confidence scores are generated based on re-training the machine learning model. At step 424, the re-trained machine learning model is executed in the payment information determining subsystem 218 to determine the one or more first payment information including at least one of: the one or more payment amounts and the one or more payment identifiers within at least one of: the one or more electronic mails and the one or more electronic documents.

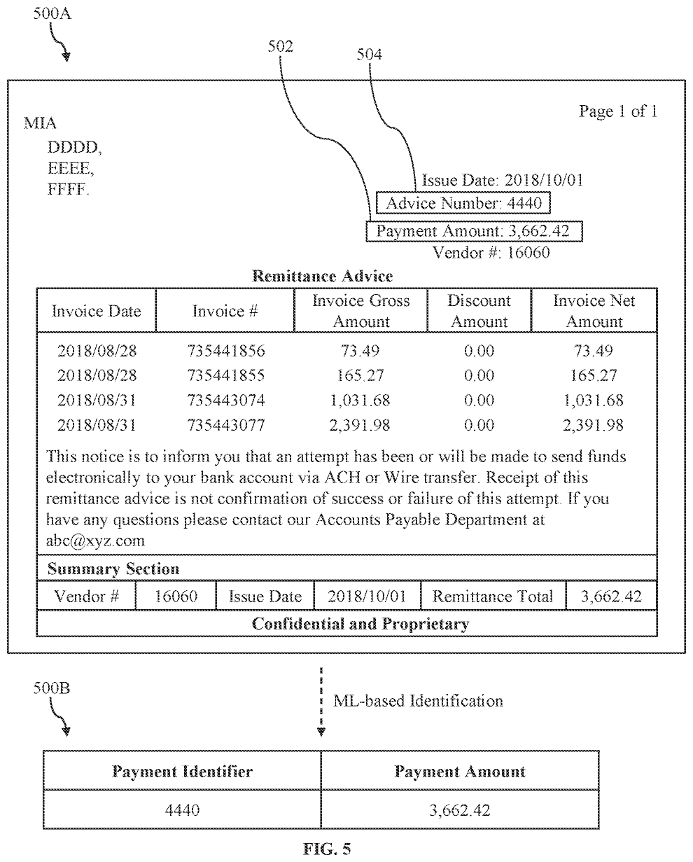

FIG. 5 are exemplary views (500A, 500B) depicting the output of the determined one or more payment information from the one or more electronic mails, on the user interface associated with the one or more electronic devices 102, in accordance with an embodiment of the present disclosure. FIG. 5A depicts an exemplary remittance document 500A that includes the one or more payment information. The payment identifier 504 is identified by the key “Advice Number” and the value is “4440”. The payment amount 502 is “3,662.42”. FIG. 5B depicts that the ML-based computing system 104 is configured to identify the payment identifier and payment amount as shown in 500B, based on the one or more confidence scores generated by the random forest based machine learning model.

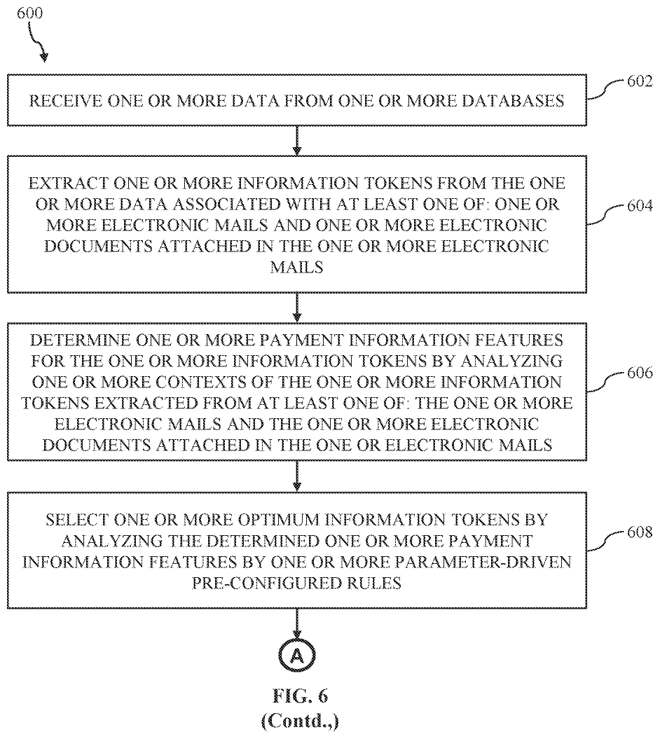

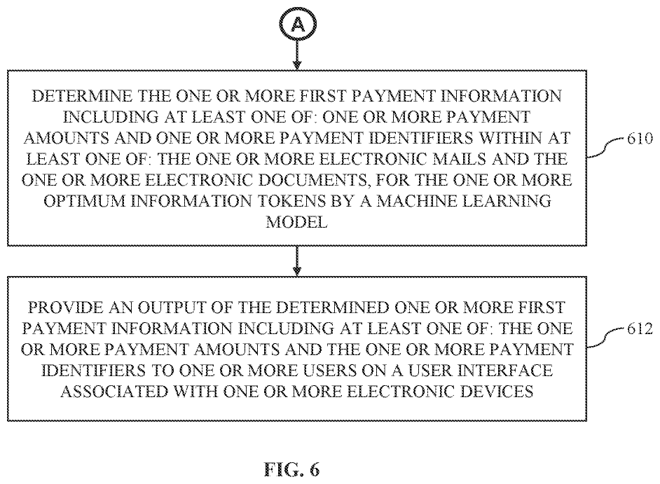

FIG. 6 is a flow chart illustrating a machine-learning based (ML-based) computing method 600 for determining the one or more payment information from the one or more electronic mails, in accordance with an embodiment of the present disclosure. At step 602, the one or more data are received from the one or more databases 108. The one or more data include at least one of: the one or more electronic mails and the one or more electronic documents attached in the one or more electronic mails.

At step 604, the one or more information tokens are extracted from the one or more data associated with at least one of: the one or more electronic mails and the one or more electronic documents attached in the one or more electronic mails.

At step 606, the one or more payment information features are determined for the one or more information tokens by analyzing one or more contexts of the one or more information tokens extracted from at least one of: the one or more electronic mails and the one or more electronic documents attached in the one or electronic mails. The one or more payment information features are configured to determine whether the one or more information tokens include the one or more contents related to the one or more first payment information. The one or more first payment information include at least one of: the one or more payment amounts and the one or more payment identifiers.

At step 608, the one or more optimum information tokens are selected by analyzing the determined one or more payment information features by the one or more parameter-driven pre-configured rules.

At step 610, the one or more first payment information including at least one of: the one or more payment amounts and the one or more payment identifiers are determined within at least one of: the one or more electronic mails and the one or more electronic documents, for the one or more optimum information tokens by the machine learning model.

At step 612, the output of the determined one or more first payment information including at least one of: the one or more payment amounts and the one or more payment identifiers to one or more users, is provided on the user interface associated with the one or more electronic devices 102. In FIG. 6, the circular symbol with “A” written inside is being used as an off-page connector. This is used for indicating that FIG. 6 continues in the next page.

The present invention has following advantages. The present invention with the ML-based computing system 104 is configured to provide the one or more payment information including at least one of: the one or more payment amounts and the one or more payment identifiers, from at least one of: the one or more electronic mails and the one or more electronic documents attached in the one or more electronic mails. The present invention with the ML-based computing system 104 is configured to minimize the human intervention in determining the one or more payment amounts and the one or more payment identifiers from the one or more electronic mails and the one or more electronic documents attached in the one or more electronic mails.

Further, the present invention is configured to determine the one or more payment information including at least one of: the one or more payment amounts and the one or more payment identifiers, from at least one of: the one or more electronic mails and the one or more electronic documents attached in the one or more electronic mails, in an automated manner without the human intervention.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based computing system 104 either directly or through intervening I/O controllers. Network adapters may also be coupled to the ML-based computing system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based computing system 104 in accordance with the embodiments herein. The ML-based computing system 104 herein comprises at least one processor or central processing unit (CPU). The CPUs are interconnected via system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based computing system 104. The ML-based computing system 104 can read the inventive instructions on the program storage devices and follow these instructions to execute the methodology of the embodiments herein.

The ML-based computing system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itsel.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine-learning based (ML-based) computing method for determining one or more payment information from one or more electronic mails, the ML-based computing method comprising:
receiving, by one or more hardware processors, one or more data from one or more databases, wherein the one or more data comprise at least one of: the one or more electronic mails and one or more electronic documents attached in the one or more electronic mails;
extracting, by the one or more hardware processors, one or more information tokens from the one or more data associated with at least one of: the one or more electronic mails and the one or more electronic documents attached in the one or more electronic mails;
determining, by the one or more hardware processors, one or more payment information features for the one or more information tokens by analyzing one or more contexts of the one or more information tokens extracted from at least one of: the one or more electronic mails and the one or more electronic documents attached in the one or electronic mails,
wherein the one or more payment information features are configured to determine whether the one or more information tokens comprise one or more contents related to one or more first payment information, wherein the one or more first payment information comprise at least one of: one or more payment amounts and one or more payment identifiers;
selecting, by the one or more hardware processors, one or more optimum information tokens by analyzing the determined one or more payment information features by one or more parameter-driven pre-configured rules;
determining, by the one or more hardware processors, the one or more first payment information comprising at least one of: the one or more payment amounts and the one or more payment identifiers within at least one of: the one or more electronic mails and the one or more electronic documents, for the one or more optimum information tokens by a machine learning model; and
providing, by the one or more hardware processors, an output of the determined one or more first payment information comprising at least one of: the one or more payment amounts and the one or more payment identifiers to one or more users on a user interface associated with one or more electronic devices.

2. The machine-learning based (ML-based) computing method of claim 1, wherein extracting the one or more information tokens comprises:
converting, by the one or more hardware processors, the one or more data associated with at least one of: the one or more electronic mails and the one or more electronic documents to one or more text formats; and
transforming, by the one or more hardware processors, the one or more text formats into the one or more information tokens, based on a tokenization process.

3. The machine-learning based (ML-based) computing method of claim 1, wherein the one or more payment information features comprise at least one of: horizontal distance from one or more first payment keywords, vertical distance from the one or more first payment keywords, horizontal distance from one or more second payment keywords, vertical distance from the one or more second payment keywords, one or more zip codes, recurrence of the one or more information tokens, and one or more positions of the one or more information tokens.

4. The machine-learning based (ML-based) computing method of claim 1, wherein determining, by the machine learning model, the one or more first payment information comprising at least one of: the one or more payment amounts and the one or more payment identifiers within at least one of: the one or more electronic mails and the one or more electronic documents, for the one or more optimum information tokens, comprises:
generating, by the one or more hardware processors, one or more confidence scores for the one or more optimum information tokens, wherein the one or more confidence scores for the one or more optimum information tokens indicate quantitative measure of the one or more first payment information comprising at least one of: the one or more payment amounts and the one or more payment identifiers, available in the one or more optimum information tokens, and
wherein the one or more confidence scores are generated for the one or more optimum information tokens based on at least one of: the determined one or more payment information features and one or more first weights assigned to the one or more payment information features based on the availability of the one or more first payment information comprising at least one of: the one or more payment amounts and the one or more payment identifiers in the one or more optimum information tokens; and
labelling, by the one or more hardware processors, the one or more optimum information tokens to classify the one or more optimum information tokens into at least one of: the one or more payment amounts, the one or more payment identifiers and one or more non-payment information, based on the one or more confidence scores generated for the one or more optimum information tokens by one or more predetermined threshold values, wherein the one or more non-payment information are distinct from the one or more first payment information.

5. The machine-learning based (ML-based) computing method of claim 4, wherein:
the one or more optimum information tokens are classified as the one or more non-payment information when the one or more confidence scores for the one or more payment amounts and the one or more payment identifiers, are within the one or more predetermined threshold values,
the one or more optimum information tokens are classified as the one or more payment amounts when at least one of: the one or more confidence scores for the one or more payment amounts are at least one of: equal and exceed the one or more predetermined threshold values, and the one or more confidence scores for the one or more payment identifiers are within the one or more predetermined threshold values,
the one or more optimum information tokens are classified as the one or more payment identifiers when at least one of: the one or more confidence scores for the one or more payment identifiers are at least one of: equal and exceed the one or more predetermined threshold values, and the one or more confidence scores for the one or more payment amounts are within the one or more predetermined threshold values, and
the one or more optimum information tokens are classified as at least one of: the one or more payment amounts and the one or more payment identifiers, based on one or more first optimum confidence scores generated for at least one of: the one or more payment amounts and the one or more payment identifiers, when at least one of: the one or more confidence scores for the one or more payment identifiers and the one or more payment amounts are at least one of: equal and exceed the one or more predetermined threshold values.

6. The machine-learning based (ML-based) computing method of claim 4, further comprising:
classifying, by the one or more hardware processors, the one or more optimum information tokens with one or more second optimum confidence scores related to the one or more payment amounts, as one or more optimum payment amounts, when the one or more confidence scores related to the one or more payment amounts are generated for the one or more optimum information tokens; and
classifying, by the one or more hardware processors, the one or more optimum information tokens with one or more third optimum confidence scores related to the one or more payment identifiers, as one or more optimum payment identifiers, when the one or more confidence scores related to the one or more payment identifiers are generated for the one or more optimum information tokens.

7. The machine-learning based (ML-based) computing method of claim 1, further comprising training, by the one or more hardware processors, the machine learning model, by:
obtaining, by the one or more hardware processors, one or more labelled datasets from the one or more databases, wherein the one or more labelled datasets comprise the one or more information tokens extracted from at least one of: the one or more electronic mails and the one or more electronic documents attached in the one or more electronic mails;
selecting, by the one or more hardware processors, one or more features vectors associated with the one or more payment information features for training the machine learning model based on a feature engineering process, wherein the machine learning model comprises a random forest based machine learning model;
labelling, by the one or more hardware processors, the one or more optimum information tokens to classify the one or more optimum information tokens into at least one of: the one or more payment amounts, the one or more payment identifiers and the one or more non-payment information;
segmenting, by the one or more hardware processors, the one or more labelled datasets into at least one of: one or more training datasets and one or more validation datasets;
training, by the one or more hardware processors, the machine learning model to correlate the one or more feature vectors associated with the one or more payment information features, with at least one of: the one or more payment amounts and the one or more payment identifiers, based on one or more hyperparameters, wherein the one or more hyperparameters comprise at least one of: max_depth, class_weight, n_estimators, min_samples_split, max_features, and min_samples_leaf,
wherein the max_depth hyperparameter is configured to control an optimum depth of each decision tree in the random forest based machine learning model, wherein the class_weight hyperparameter is configured to adjust one or more second weights of one or more classes in the random forest based machine learning model to control one or more class imbalance errors, wherein the n_estimators hyperparameter is configured to indicate a number of one or more decision trees to be included in the random forest based machine learning model, wherein the min_samples_split hyperparameter is configured to set a pre-determined number of one or more data points required in a node before the one or more data points split during a tree-building process,
wherein the max_features hyperparameter is configured to determine an optimum number of the one or more payment information features when the optimum split of the one or more payment information features at each node in the random forest based machine learning model, wherein the min_samples_leaf is configured to indicate the pre-determined number of one or more data points required to generate a leaf node during the tree-building process; and
generating, by the one or more hardware processors, the one or more confidence scores for the one or more optimum information tokens, based on the trained machine learning model.

8. The machine-learning based (ML-based) computing method of claim 7, further comprising validating, by the one or more hardware processors, the machine learning model based on the one or more validation datasets, wherein validating the machine learning model comprises:
determining, by the one or more hardware processors, whether one or more metric scores attained by the trained machine learning model, exceeds one or more pre-determined threshold values, wherein the one or more metric scores are associated with one or more validation metrics comprising at least one of: precision metric, recall metric, F1-score metric, and confusion metric.

9. The machine-learning based (ML-based) computing method of claim 8, further comprising adjusting, by the one or more hardware processors, the one or more hyperparameters to fine-tune the machine learning model based on one or more results of validation of the machine learning model.

10. The machine-learning based (ML-based) computing method of claim 7, further comprising re-training, by the one or more hardware processors, the machine learning model over a plurality of time intervals based on one or more training data, wherein re-training the machine learning model over the plurality of time intervals comprises:
receiving, by the one or more hardware processors, the one or more training data associated with at least one of: the one or more electronic mails and the one or more electronic documents attached in the one or more electronic mails;
adding, by the one or more hardware processors, the one or more training data with the one or more training datasets to generate one or more updated training datasets;
re-training, by the one or more hardware processors, the machine learning model to correlate the one or more feature vectors associated with the one or more payment information features, with at least one of: the one or more payment amounts and the one or more payment identifiers, wherein the one or more confidence scores are generated based on re-training the machine learning model; and
executing, by the one or more hardware processors, the re-trained machine learning model in a payment information determining subsystem to determine the one or more first payment information comprising at least one of: the one or more payment amounts and the one or more payment identifiers within at least one of: the one or more electronic mails and the one or more electronic documents.

11. A machine learning based (ML-based) computing system for determining one or more payment information from one or more electronic mails, the ML-based computing system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
a data receiving subsystem configured to receive one or more data from one or more databases, wherein the one or more data comprise at least one of: the one or more electronic mails and one or more electronic documents attached in the one or more electronic mails;
a token extraction subsystem configured to extract one or more information tokens from the one or more data associated with at least one of: the one or more electronic mails and the one or more electronic documents attached in the one or more electronic mails;
a payment information feature determining subsystem configured to determine one or more payment information features for the one or more information tokens by analyzing one or more contexts of the one or more information tokens extracted from at least one of: the one or more electronic mails and the one or more electronic documents attached in the one or electronic mails,
wherein the one or more payment information features are configured to determine whether the one or more information tokens comprise one or more contents related to one or more first payment information, wherein the one or more first payment information comprise at least one of: one or more payment amounts and one or more payment identifiers;
a token selection subsystem configured to select one or more optimum information tokens by analyzing the determined one or more payment information features by one or more parameter-driven pre-configured rules;
a payment information determining subsystem configured to determine the one or more first payment information comprising at least one of: the one or more payment amounts and the one or more payment identifiers within at least one of: the one or more electronic mails and the one or more electronic documents, for the one or more optimum information tokens by a machine learning model; and
an output subsystem configured to provide an output of the determined one or more first payment information comprising at least one of: the one or more payment amounts and the one or more payment identifiers to one or more users on a user interface associated with one or more electronic devices.

12. The machine-learning based (ML-based) computing system of claim 11, wherein in extracting the one or more information tokens, the token extraction subsystem is configured to:
convert the one or more data associated with at least one of: the one or more electronic mails and the one or more electronic documents to one or more text formats; and
transform the one or more text formats into the one or more information tokens, based on a tokenization process.

13. The machine-learning based (ML-based) computing system of claim 11, wherein in determining the one or more first payment information comprising at least one of: the one or more payment amounts and the one or more payment identifiers within at least one of: the one or more electronic mails and the one or more electronic documents, for the one or more optimum information tokens, the payment information determining subsystem is configured to:
generate one or more confidence scores for the one or more optimum information tokens, wherein the one or more confidence scores for the one or more optimum information tokens indicate quantitative measure of the one or more first payment information comprising at least one of: the one or more payment amounts and the one or more payment identifiers, available in the one or more optimum information tokens, and
wherein the one or more confidence scores are generated for the one or more optimum information tokens based on at least one of: the determined one or more payment information features and one or more first weights assigned to the one or more payment information features based on the availability of the one or more first payment information comprising at least one of: the one or more payment amounts and the one or more payment identifiers in the one or more optimum information tokens; and
label the one or more optimum information tokens to classify the one or more optimum information tokens into at least one of: the one or more payment amounts, the one or more payment identifiers and one or more non-payment information, based on the one or more confidence scores generated for the one or more optimum information tokens by one or more predetermined threshold values, wherein the one or more non-payment information are distinct from the one or more first payment information.

14. The machine-learning based (ML-based) computing system of claim 13, wherein:
the one or more optimum information tokens are classified as the one or more non-payment information when the one or more confidence scores for the one or more payment amounts and the one or more payment identifiers, are within the one or more predetermined threshold values,
the one or more optimum information tokens are classified as the one or more payment amounts when at least one of: the one or more confidence scores for the one or more payment amounts are at least one of: equal and exceed the one or more predetermined threshold values, and the one or more confidence scores for the one or more payment identifiers are within the one or more predetermined threshold values,
the one or more optimum information tokens are classified as the one or more payment identifiers when at least one of: the one or more confidence scores for the one or more payment identifiers are at least one of: equal and exceed the one or more predetermined threshold values, and the one or more confidence scores for the one or more payment amounts are within the one or more predetermined threshold values, and
the one or more optimum information tokens are classified as at least one of: the one or more payment amounts and the one or more payment identifiers, based on one or more first optimum confidence scores generated for at least one of: the one or more payment amounts and the one or more payment identifiers, when at least one of: the one or more confidence scores for the one or more payment identifiers and the one or more payment amounts are at least one of: equal and exceed the one or more predetermined threshold values.

15. The machine-learning based (ML-based) computing system of claim 13, wherein the payment information determining subsystem is further configured to:
classify the one or more optimum information tokens with one or more second optimum confidence scores related to the one or more payment amounts, as one or more optimum payment amounts, when the one or more confidence scores related to the one or more payment amounts are generated for the one or more optimum information tokens; and
classify the one or more optimum information tokens with one or more third optimum confidence scores related to the one or more payment identifiers, as one or more optimum payment identifiers, when the one or more confidence scores related to the one or more payment identifiers are generated for the one or more optimum information tokens.

16. The machine-learning based (ML-based) computing method of claim 11, further comprising a training subsystem configured to train the machine learning model, wherein in training the machine learning model, the training subsystem is configured to:
obtain one or more labelled datasets from the one or more databases, wherein the one or more labelled datasets comprise the one or more information tokens extracted from at least one of: the one or more electronic mails and the one or more electronic documents attached in the one or more electronic mails;
select one or more features vectors associated with the one or more payment information features for training the machine learning model based on a feature engineering process, wherein the machine learning model is a random forest based machine learning model;
label the one or more optimum information tokens to classify, the one or more optimum information tokens into at least one of: the one or more payment amounts, the one or more payment identifiers and the one or more non-payment information;
segment the one or more labelled datasets into at least one of: one or more training datasets and one or more validation datasets,
train the machine learning model to correlate the one or more feature vectors associated with the one or more payment information features, with at least one of: the one or more payment amounts and the one or more payment identifiers, based on one or more hyperparameters, wherein the one or more hyperparameters comprise at least one of: max_depth, class_weight, n_estimators, min_samples_split, max_features, and min_samples_leaf,
wherein the max_depth hyperparameter is configured to control an optimum depth of each decision tree in the random forest based machine learning model, wherein the class_weight hyperparameter is configured to adjust the one or more second weights of one or more classes in the random forest based machine learning model to control one or more class imbalance errors, wherein the n_estimators hyperparameter is configured to indicate a number of one or more decision trees to be included in the random forest based machine learning model, wherein the min_samples_split hyperparameter is configured to set a pre-determined number of one or more data points required in a node before the one or more data points split during a tree-building process,
wherein the max_features hyperparameter is configured to determine an optimum number of the one or more payment information features when the optimum split of the one or more payment information features at each node in the random forest based machine learning model, wherein the min_samples_leaf is configured to indicate the pre-determined number of one or more data points required to generate a leaf node during the tree-building process; and
generate the one or more confidence scores for the one or more optimum information tokens, based on the trained machine learning model.

17. The machine-learning based (ML-based) computing system of claim 16, wherein the training subsystem is further configured to validate the machine learning model based on one or more validation datasets, and wherein in validating the machine learning model, the training subsystem is configured to:
determine whether one or more metric scores attained by the trained machine learning model, exceeds one or more pre-determined threshold values, wherein the one or more metric scores are associated with one or more validation metrics comprising at least one of: precision metric, recall metric, F1-score metric, and confusion metric.

18. The machine-learning based (ML-based) computing system of claim 17, wherein the training subsystem is further configured to adjust the one or more hyperparameters to fine-tune the machine learning model based on one or more results of validation of the machine learning model.

19. The machine-learning based (ML-based) computing system of claim 10, wherein the training subsystem is further configured to re-train the machine learning model over a plurality of time intervals based on one or more training data, wherein in re-training the machine learning model over the plurality of time intervals, the training subsystem is configured to:
receive the one or more training data associated with at least one of: the one or more electronic mails and the one or more electronic documents attached in the one or more electronic mails;
add the one or more training data with the one or more training datasets to generate one or more updated training datasets;
re-train the machine learning model to correlate the one or more feature vectors associated with the one or more payment information features, with at least one of: the one or more payment amounts and the one or more payment identifiers, wherein the one or more confidence scores are generated based on re-training the machine learning model; and
execute the re-trained machine learning model in a payment information determining subsystem to determine the one or more first payment information comprising at least one of: the one or more payment amounts and the one or more payment identifiers within at least one of: the one or more electronic mails and the one or more electronic documents.

20. A non-transitory computer-readable storage medium having instructions stored therein that when executed by a hardware processor, cause the processor to execute operations of:
receiving one or more data from one or more databases, wherein the one or more data comprise at least one of the one or more electronic mails and one or more electronic documents attached in the one or more electronic mails;
extracting one or more information tokens from the one or more data associated with at least one of: the one or more electronic mails and the one or more electronic documents attached in the one or more electronic mails;
determining one or more payment information features for the one or more information tokens by analyzing one or more contexts of the one or more information tokens extracted from at least one of: the one or more electronic mails and the one or more electronic documents attached in the one or electronic mails,
wherein the determined one or more payment information features are configured to determine whether the one or more information tokens comprise one or more contents related to one or more first payment information, wherein the one or more first payment information comprise at least one of: one or more payment amounts and one or more payment identifiers;
selecting one or more optimum information tokens by analyzing the determined one or more payment information features by one or more parameter-driven pre-configured rules;
determining the one or more first payment information comprising at least one of: the one or more payment amounts and the one or more payment identifiers within at least one of: the one or more electronic mails and the one or more electronic documents, for the one or more optimum information tokens by a machine learning model; and
providing an output of the determined one or more first payment information comprising at least one of: the one or more payment amounts and the one or more payment identifiers to one or more users on a user interface associated with one or more electronic devices.
